(19) United States
(12) Patent Application Publication
(10) Pub. No.: US 2023/0007107 A1
(43) Pub. Date: Jan. 5, 2023

(54) CONVERTING CONTROL AREA NETWORK DATA TO ROBOTIC OPERATING SYSTEM DATA

(71) Applicant: GM Cruise Holdings LLC, San Francisco, CA (US)

(72) Inventors: ShuTing Guo, San Francisco, CA (US); Ashwin Raut, San Francisco, CA (US); Joshua Leighton, San Francisco, CA (US); Nick Miller, San Francisco, CA (US)

(21) Appl. No.: 17/364,817

(22) Filed: Jun. 30, 2021

(51) Int. Cl. H04L 29/08; G05B 13/02; B60R 16/023

(52) U.S. Cl. CPC H04L 69/325; G05B 13/02; H04L 67/12; B60R 16/0231

(57) ABSTRACT

Methods and systems are provided for facilitating communications between an internal computing system and vehicle electronic control units. In some aspects, methods and systems are provided and can include receiving data from a plurality of vehicle electronic control units, the data from the plurality of vehicle electronic control units being processed by utilizing a control area network protocol, processing the data received from the plurality of vehicle electronic control units by utilizing a robotic operating system protocol, and providing robotic operating system data based on the data processed by utilizing the robotic operating system protocol to an internal computing system.

### BACKGROUND

### 1. Technical Field

The subject technology provides solutions for autonomous vehicles, and in particular, for facilitating communications between an internal computing system and vehicle electronic control units.

### 2. Introduction

Autonomous vehicles are vehicles having computers and control systems that perform driving and navigation tasks that are conventionally performed by a human driver. As autonomous vehicle technologies continue to advance, ride-sharing services will increasingly utilize autonomous vehicles to improve service efficiency and safety. However, autonomous vehicles will be required to perform many of the functions that are conventionally performed by human drivers, such as avoiding dangerous or difficult routes, and performing other navigation and routing tasks necessary to provide a safe and efficient transportation. Such tasks may require the collection and processing of large quantities of data disposed on the autonomous vehicle.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates an example system environment that can be used to facilitate autonomous vehicle navigation and routing operations, according to some aspects of the disclosed technology.

FIG. 2 illustrates an example system environment that can be used to facilitate autonomous vehicle navigation and routing operations with an advanced driving interface module driver, according to some aspects of the disclosed technology.

FIG. 3 illustrates an example process of facilitating communications between an internal computing system and vehicle electronic control units, according to some aspects of the disclosed technology.

FIG. 4 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

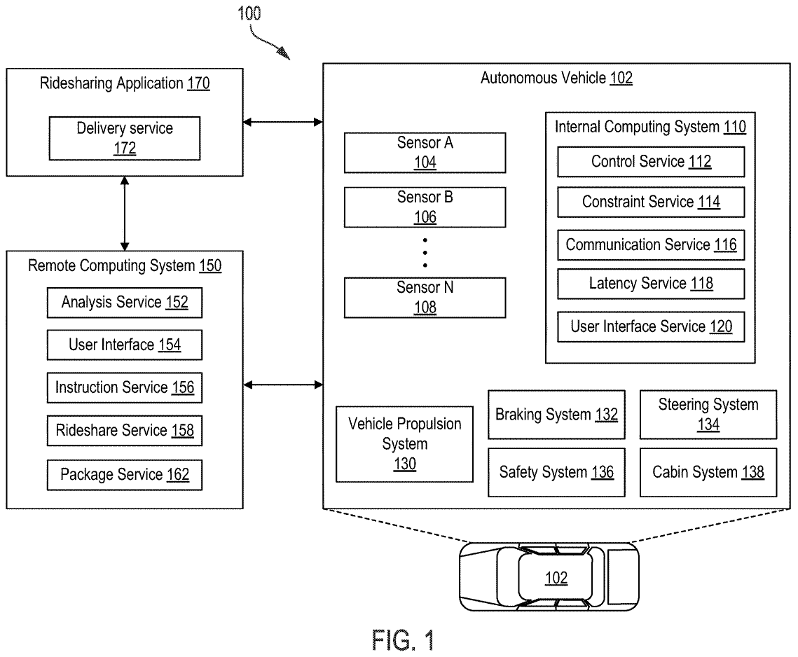

FIG. 1 illustrates an example system environment 100 that can be used to facilitate AV dispatch and operations, according to some aspects of the disclosed technology. Autonomous vehicle 102 can navigate about roadways without a human driver based upon sensor signals output by sensor systems 104-106 of autonomous vehicle 102. Autonomous vehicle 102 includes a plurality of sensor systems 104-106 (a first sensor system 104 through an Nth sensor system 106). Sensor systems 104-106 are of different types and are arranged about the autonomous vehicle 102. For example, first sensor system 104 may be a camera sensor system and the Nth sensor system 106 may be a Light Detection and Ranging (LIDAR) sensor system. Other exemplary sensor systems include radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems such as Global Positioning System (GPS) receiver systems, accelerometers, gyroscopes, inertial measurement units (IMU), infrared sensor systems, laser rangefinder systems, ultrasonic sensor systems, infrasonic sensor systems, microphones, or a combination thereof. While four sensors 180 are illustrated coupled to the autonomous vehicle 102, it is understood that more or fewer sensors may be coupled to the autonomous vehicle 102.

Autonomous vehicle 102 further includes several mechanical systems that are used to effectuate appropriate motion of the autonomous vehicle 102. For instance, the mechanical systems can include but are not limited to, vehicle propulsion system 130, braking system 132, and steering system 134. Vehicle propulsion system 130 may include an electric motor, an internal combustion engine, or both. The braking system 132 can include an engine brake, brake pads, actuators, and/or any other suitable componentry that is configured to assist in decelerating autonomous vehicle 102. In some cases, braking system 132 may charge a battery of the vehicle through regenerative braking. Steering system 134 includes suitable componentry that is configured to control the direction of movement of the autonomous vehicle 102 during navigation.

Autonomous vehicle 102 further includes a safety system 136 that can include various lights and signal indicators, parking brake, airbags, etc. Autonomous vehicle 102 further includes a cabin system 138 that can include cabin temperature control systems, in-cabin entertainment systems, etc.

Autonomous vehicle 102 additionally comprises an internal computing system 110 that is in communication with sensor systems 180 and systems 130, 132, 134, 136, and 138. Internal computing system 110 includes at least one processor and at least one memory having computer-executable instructions that are executed by the processor. The computer-executable instructions can make up one or more services responsible for controlling autonomous vehicle 102, communicating with remote computing system 150, receiving inputs from passengers or human co-pilots, logging metrics regarding data collected by sensor systems 180 and human co-pilots, etc.

Internal computing system 110 can include a control service 112 that is configured to control operation of vehicle propulsion system 130, braking system 132, steering system 134, safety system 136, and cabin system 138. Control service 112 receives sensor signals from sensor systems 180 as well communicates with other services of internal computing system 110 to effectuate operation of autonomous vehicle 102. In some embodiments, control service 112 may carry out operations in concert one or more other systems of autonomous vehicle 102.

Internal computing system 110 can also include constraint service 114 to facilitate safe propulsion of autonomous vehicle 102. Constraint service 116 includes instructions for activating a constraint based on a rule-based restriction upon operation of autonomous vehicle 102. For example, the constraint may be a restriction upon navigation that is activated in accordance with protocols configured to avoid occupying the same space as other objects, abide by traffic laws, circumvent avoidance areas, etc. In some embodiments, the constraint service can be part of control service 112.

The internal computing system 110 can also include communication service 116. The communication service 116 can include both software and hardware elements for transmitting and receiving signals from/to the remote computing system 150. Communication service 116 is configured to transmit information wirelessly over a network, for example, through an antenna array that provides connectivity using one or more cellular transmission standards, such as long-term evolution (LTE), 3G, 5G, or the like.

In some embodiments, one or more services of the internal computing system 110 are configured to send and receive communications to remote computing system 150 for such reasons as reporting data for training and evaluating machine learning algorithms, requesting assistance from remoting computing system or a human operator via remote computing system 150, software service updates, ridesharing pickup and drop off instructions etc.

Internal computing system 110 can also include latency service 118. Latency service 118 can utilize timestamps on communications to and from remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150 as information can quickly become too stale to be actionable. When the latency service 118 determines that a response has not been received within a threshold, latency service 118 can enable other systems of autonomous vehicle 102 or a passenger to make necessary decisions or to provide the needed feedback.

Internal computing system 110 can also include a user interface service 120 that can communicate with cabin system 138 in order to provide information or receive information to a human co-pilot or human passenger. In some embodiments, a human co-pilot or human passenger may be required to evaluate and override a constraint from constraint service 114, or the human co-pilot or human passenger may wish to provide an instruction to the autonomous vehicle 102 regarding destinations, requested routes, or other requested operations.

As described above, the remote computing system 150 is configured to send/receive a signal from the autonomous vehicle 140 regarding reporting data for training and evaluating machine learning algorithms, requesting assistance from remote computing system 150 or a human operator via the remote computing system 150, software service updates, rideshare pickup and drop off instructions, etc.

Remote computing system 150 includes an analysis service 152 that is configured to receive data from autonomous vehicle 102 and analyze the data to train or evaluate machine learning algorithms for operating the autonomous vehicle 102. The analysis service 152 can also perform analysis pertaining to data associated with one or more errors or constraints reported by autonomous vehicle 102.

Remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

Remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102.

Remote computing system 150 can also include rideshare service 158 configured to interact with ridesharing applications 170 operating on (potential) passenger computing devices. The rideshare service 158 can receive requests to be picked up or dropped off from passenger ridesharing app 170 and can dispatch autonomous vehicle 102 for the trip. The rideshare service 158 can also act as an intermediary between the ridesharing app 170 and the autonomous vehicle wherein a passenger might provide instructions to the autonomous vehicle to 102 go around an obstacle, change routes, honk the horn, etc.

As described herein, one aspect of the present technology is to provide an autonomous vehicle system that can provide communications between an internal computing system and vehicle electronic control units. The present disclosure contemplates that in some instances, the communications between the internal computing system and the vehicle electronic control units include processing control area network (CAN) data received from various sensors throughout the system into robotic operating system (ROS) data.

Currently, a large amount of data is received from various sensors utilized by autonomous vehicles at any given time. For example, data is received from sensors associated with vehicle propulsion, braking, steering, and safety. For autonomous vehicles, the data from the sensors are constantly being received by the autonomous to provide real-time decisions and determinations. In some examples, if the sensors detect that a pedestrian is entering the zone of travel of the autonomous vehicle, it is imperative that the autonomous vehicle react accordingly, and quickly. However, as a large amount of data is constantly being received from all of the sensors, the data associated with the above-mentioned pedestrian may not be processed by the autonomous vehicle in a timely manner that avoids the pedestrian. Another factor that contributes to the delayed reaction of the autonomous vehicle is the processing time and effort to process raw sensor data into a useable form, e.g., into robotic operating system data.

Aspects of the disclosed technology address the foregoing limitations of conventional receipt of raw sensor data by an autonomous vehicle system by processing the raw sensor data into robotic operating system data that can be utilized by the autonomous vehicle system.

As discussed in further detail below, methods and systems are provided for facilitating communications between an internal computing system and vehicle electronic control units. In some aspects, methods and systems are provided and can include receiving data from a plurality of vehicle electronic control units, the data from the plurality of vehicle electronic control units being processed by utilizing a control area network protocol, processing the data received from the plurality of vehicle electronic control units by utilizing a robotic operating system protocol, and providing robotic operating system data based on the data processed by utilizing the robotic operating system protocol to an internal computing system.

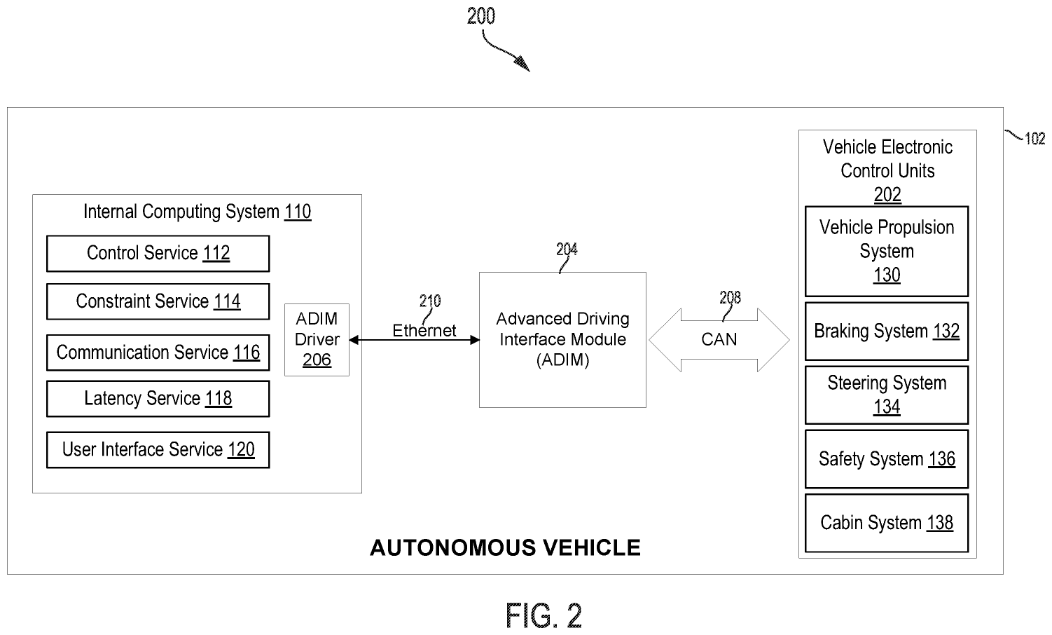

FIG. 2 illustrates an example system environment that can be used to facilitate autonomous vehicle navigation and routing operations with an advanced driving interface module driver 200, according to some aspects of the disclosed technology. In some implementations, the autonomous vehicle system 200 can include an autonomous vehicle 102 (e.g., as shown in FIG. 1) including an internal computing system 110, vehicle electronic control units (ECUs) 202, an advanced driving interface module (ADIM) 204, and an ADIM driver 206.

Referring to FIG. 2, the internal computing system 110 of the autonomous vehicle system 200 can include a control service 112, a constraint service 114, a communication service 116, a latency service 118, a user interface service 120, as described herein, and any other autonomous vehicle services suitable for the intended purpose and understood by a person of ordinary skill in the art. The above-mentioned services of the internal computing system 110 can be utilized to control and operate the autonomous vehicle 102.

In other implementations, the vehicle ECUs 202 of the autonomous vehicle system 200 can include a vehicle propulsion system 130, a braking system 132, a steering system 134, a safety system 136, a cabin system 138, as described herein, and any other ECU suitable for the intended purpose and understood by a person of ordinary skill in the art to control various aspects of the autonomous vehicle 102. Each of the above-mentioned systems can further include and utilize sensors (e.g., sensor A 104, sensor B, 106, sensor N 108, etc.) that are configured to receive data. For example, accelerometer sensors can provide acceleration data, camera sensors can provide image data, and temperature sensors can provide cabin temperature data to the autonomous vehicle system 200.

In some examples, the ADIM 204 of the autonomous vehicle system 200 can be communicatively coupled to the vehicle ECUs 202 and the internal computing system 110. For example, the ADIM 204 can utilize a control area network (CAN) protocol 208 to communicate with the vehicle ECUs 202. In some implementations, the vehicle propulsion system 130, the braking system 132, the steering system 134, the safety system 136, and the cabin system 138 can convert their respective raw sensor data into CAN data by utilizing a CAN protocol, or their respective raw sensor data can initially be CAN data that may be distributed throughout via a CAN bus. The CAN data can be provided to the ADIM 204 to then to be provided to the internal computing system 110 via an Ethernet connection 210. In some examples, the ADIM 204 can utilize a CAN database file (“DBC”) to decode the CAN data to a pre-determined format. In some implementations, the vehicle ECUs 202 of the autonomous vehicle 102 can generate CAN messages that can then be passed through via the ADIM 204 to the ADIM driver 206. The ADIM driver 206 can convert the CAN messages into usable information for a variety of vehicle controls and decision making processes such as vehicle motion controls, auxiliary controls (e.g., door, window, HVAC, etc.), and system state computing (e.g., the control service 112, the constraint service 114, the communication service 116, the latency service 118, and the user interface service 120).

Once the CAN data is decoded by the ADIM 204 of the autonomous vehicle system 200, the ADIM 204 can utilize an Ethernet protocol to convert the data received from the vehicle ECUs 202 into a format that can then be provided to the internal computing system 110. In some examples, the data provided by the ADIM 205 can also be provided to the ADIM driver 206 to further process the data so that the data may be usable by the internal computing system 110. The conversion process of the ADIM driver 206 can establish an abstraction layer between the internal computing system 110 and the vehicle ECUs 202 of the autonomous vehicle system 200 to consume information and data from various sensors of the vehicle ECUs 202.

In some implementations, the ADIM driver 206 of the autonomous vehicle system 200 may be a part of the internal computing system 110. The ADIM 204 and the ADIM driver 206 can include corresponding Ethernet interfaces to utilize an Ethernet connection 210 to communicate with one another. In some examples, the ADIM driver 206 can utilize a robotic operating system (ROS) protocol to decode the data received from the ADIM 204, which can then be provided to the respective systems of the internal computing system 110 (e.g., the control service 112, the constraint service 114, the communication service 116, the latency service 118, and the user interface service 120). Utilizing a ROS protocol can provide the autonomous vehicle system 200 with hardware abstraction, low-level device control, implementation of device functionality, message-passing between systems and processes, and package management. The autonomous vehicle system 200 can reference a set of DBC files that can include definitions of all of the CAN messages, which can be utilized by the ADIM driver 206 to automatically generate corresponding message structures for the conversions of the raw CAN data into usable information that can be recognized and understood by the internal computing system 110.

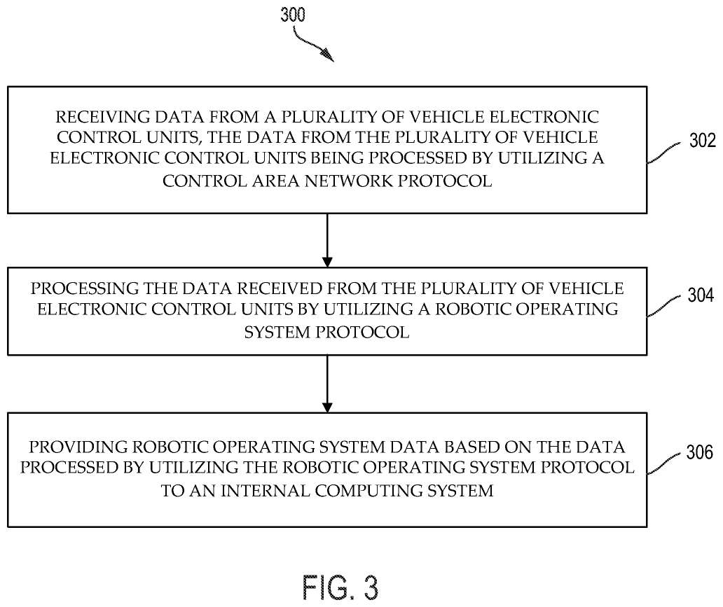

Having disclosed some example system components and concepts, the disclosure now turns to FIG. 3, which illustrates an example method 300 for facilitating communications between an internal computing system and vehicle electronic control units. The steps outlined herein are exemplary and can be implemented in any combination thereof, including combinations that exclude, add, or modify certain steps.

At step 302, method 300 can include receiving, at an advanced driving interface module driver, data from a plurality of vehicle electronic control units, the data from the plurality of vehicle electronic control units being processed by utilizing a control area network protocol. The receiving of the data from the plurality of vehicle electronic control units can be over an Ethernet connection. Control area network data can be processed by utilizing an Ethernet protocol. The processing of the data received from the plurality of vehicle electronic control units can include processing the control area network data by utilizing the Ethernet protocol.

In some implementations, the data from the plurality of vehicle electronic control units can include sensor data from a plurality of sensors distributed throughout an autonomous vehicle.

At step 304, method 300 can include processing, by the advanced driving interface module driver, the data received from the plurality of vehicle electronic control units by utilizing a robotic operating system protocol. The processing of the data received from the plurality of vehicle electronic control units can include converting control area network data into robotic operating system data.

At step 306, method 300 can include providing, by the advanced driving interface module driver, robotic operating system data based on the data processed by utilizing the robotic operating system protocol to an internal computing system.

The method 300 can further include processing, by an advanced driving interface module, control area network data received from the plurality of vehicle electronic control units into Ethernet data, and providing, by the advanced driving interface module, the Ethernet data to the advanced driving interface module driver.

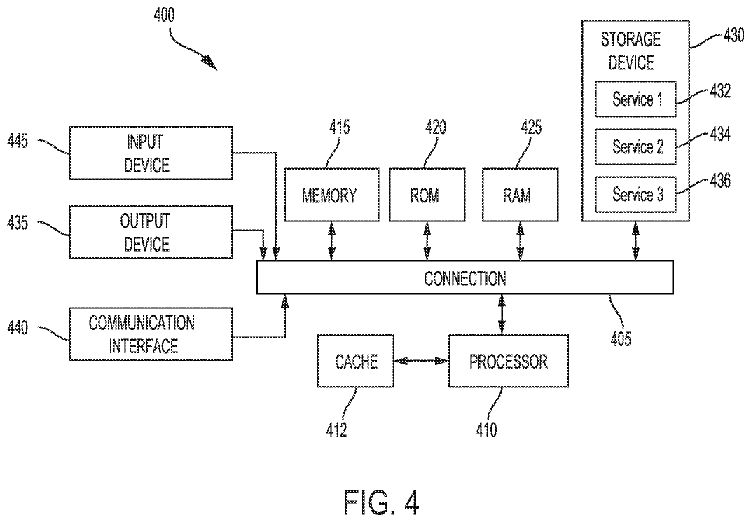

FIG. 4 illustrates an example processor-based system with which some aspects of the subject technology can be implemented. For example, processor-based system 400 that can be any computing device making up internal computing system 110, remote computing system 150, a passenger device executing the rideshare app 170, internal computing device 130, or any component thereof in which the components of the system are in communication with each other using connection 405. Connection 405 can be a physical connection via a bus, or a direct connection into processor 410, such as in a chipset architecture. Connection 405 can also be a virtual connection, networked connection, or logical connection.

In some embodiments, computing system 400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 400 includes at least one processing unit (CPU or processor) 410 and connection 405 that couples various system components including system memory 415, such as read-only memory (ROM) 420 and random-access memory (RAM) 425 to processor 410. Computing system 400 can include a cache of high-speed memory 412 connected directly with, in close proximity to, and/or integrated as part of processor 410.

Processor 410 can include any general-purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 440 may also include one or more Global Navigation Satellite System (GNSS) receivers or transceivers that are used to determine a location of the computing system 400 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 430 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

Storage device 430 can include software services, servers, services, etc., that when the code that defines such software is executed by the processor 410, it causes the system to perform a function. In some embodiments, a hardware service that performs a particular function can include the software component stored in a computer-readable medium in connection with the necessary hardware components, such as processor 410, connection 405, output device 435, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. By way of example computer-executable instructions can be used to implement perception system functionality for determining when sensor cleaning operations are needed or should begin. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A computer-implemented method comprising:
receiving, at an advanced driving interface module driver, data from a plurality of vehicle electronic control units, the data from the plurality of vehicle electronic control units being processed by utilizing a control area network protocol;
processing, by the advanced driving interface module driver, the data received from the plurality of vehicle electronic control units by utilizing a robotic operating system protocol; and
providing, by the advanced driving interface module driver, robotic operating system data based on the data processed by utilizing the robotic operating system protocol to an internal computing system.

2. The computer-implemented method of claim 1, wherein the receiving of the data from the plurality of vehicle electronic control units is over an Ethernet connection.

3. The computer-implemented method of claim 2, wherein control area network data is processed by utilizing an Ethernet protocol.

4. The computer-implemented method of claim 3, wherein the processing of the data received from the plurality of vehicle electronic control units includes processing the control area network data by utilizing the Ethernet protocol.

5. The computer-implemented method of claim 1, wherein the data from the plurality of vehicle electronic control units includes sensor data from a plurality of sensors distributed throughout an autonomous vehicle.

6. The computer-implemented method of claim 1, wherein the processing of the data received from the plurality of vehicle electronic control units includes converting control area network data into robotic operating system data.

7. The computer-implemented method of claim 1, further comprising:
processing, by an advanced driving interface module, control area network data received from the plurality of vehicle electronic control units into Ethernet data; and
providing, by the advanced driving interface module, the Ethernet data to the advanced driving interface module driver.

8. A system comprising:
one or more processors; and
at least one computer-readable storage medium having stored therein instructions which, when executed by the one or more processors, cause the simulation system to:
receive data from a plurality of vehicle electronic control units, the data from the plurality of vehicle electronic control units being processed by utilizing a control area network protocol;
process the data from the plurality of vehicle electronic control units by utilizing a robotic operating system protocol; and
provide robotic operating system data based on the data processed by utilizing the robotic operating system protocol to an internal computing system.

9. The system of claim 8, wherein the receipt of the data from the plurality of vehicle electronic control units is over an Ethernet connection.

10. The system of claim 9, wherein control area network data is processed by utilizing an Ethernet protocol.

11. The system of claim 10, wherein the data received from the plurality of vehicle electronic control units includes the control area network data that is processed by utilizing the Ethernet protocol.

12. The system of claim 8, wherein the data from the plurality of vehicle electronic control units includes sensor data from a plurality of sensors distributed throughout an autonomous vehicle.

13. The system of claim 8, wherein the data received from the plurality of vehicle electronic control units includes control area network data that is converted into robotic operating system data.

14. The system of claim 8, wherein the instructions which, when executed by the one or more processors, cause the system to:
process control area network data received from the plurality of vehicle electronic control units into Ethernet data; and
provide the Ethernet data to the internal computing system.

15. A non-transitory computer-readable storage medium comprising:
instructions stored on the non-transitory computer-readable storage medium, the instructions, when executed by one more processors, cause the one or more processors to:
receive data from a plurality of vehicle electronic control units, the data from the plurality of vehicle electronic control units being processed by utilizing a control area network protocol;
process the data from the plurality of vehicle electronic control units by utilizing a robotic operating system protocol; and
provide robotic operating system data based on the data processed by utilizing the robotic operating system protocol to an internal computing system.

16. The non-transitory computer-readable storage medium of claim 15, wherein the receipt of the data from the plurality of vehicle electronic control units is over an Ethernet connection.

17. The non-transitory computer-readable storage medium of claim 16, wherein control area network data is processed by utilizing an Ethernet protocol.

18. The non-transitory computer-readable storage medium of claim 17, wherein the data received from the plurality of vehicle electronic control units includes the control area network data that is processed by utilizing the Ethernet protocol.

19. The non-transitory computer-readable storage medium of claim 15, wherein the data from the plurality of vehicle electronic control units includes sensor data from a plurality of sensors distributed throughout an autonomous vehicle.

20. The non-transitory computer-readable storage medium of claim 15, wherein the data received from the plurality of vehicle electronic control units includes control area network data that is converted into robotic operating system data.
